(19) United States
(12) Patent Application Publication
(10) Pub. No.: US 2022/0341716 A1
(43) Pub. Date: Oct. 27, 2022

(54) AUTOMATED DART SCORING SYSTEM AND METHOD

(71) Applicants: William Mark McNally, Cambridge (CA); John Joseph McPhee, Waterloo (CA); Alexander Sheung Lai Wong, Waterloo (CA)

(72) Inventors: William Mark McNally, Cambridge (CA); John Joseph McPhee, Waterloo (CA); Alexander Sheung Lai Wong, Waterloo (CA)

(21) Appl. No.: 17/723,185

(22) Filed: Apr. 18, 2022

Related U.S. Application Data
(60) Provisional application No. 63/258,163, filed on Apr. 16, 2021.

(51) Int. Cl. F41J 3/02; A63F 11/00; G06T 7/70; G06N 3/08

(52) U.S. Cl. CPC F41J 3/02; A63F 11/0051; G06T 7/70; G06N 3/08; A63F 2011/0058; G06T 2207/20081; G06T 2207/20084; G06T 2207/30221

(57) ABSTRACT

A method for automatically computing the position and score for each dart on a dartboard using a single image of the dart and dartboard captured from any camera angle. A computing device with at least one connected camera captures an image of a dartboard. The computing device performs various image processing tasks and computes the landing position of each dart present in the image and the positions of multiple dartboard calibration points. The dartboard calibration points are used to compute a transformation matrix that transforms the detected points in the image plane to corresponding points in the dartboard plane. The score of each dart is computed based on the relative positioning of the transformed points in the dartboard plane. The method may be used to perform automatic scorekeeping in a variety of different dart games, either in a single location or in remote locations.

### RELATED APPLICATIONS

This application claims the benefit of U.S. Appl. No. 63/258,163 filed on Apr. 16, 2021, entitled Automated Dart Scoring Method Using a Single Image, which is incorporated by reference herein in its entirety.

### FIELD

The present invention generally relates to a system and method for automatically scoring a dart-board using image data and image processing tasks.

### BACKGROUND

Darts is a game in which pointed projectiles (the darts) are thrown at a circular target known as a dartboard. A dart is made of four components, including the tip, barrel, shaft, and flight, as shown in FIG. 1. The game of darts is traditionally played between two players using a bristle dartboard and a set of steel-tipped darts. Each player throws darts in turn, and points are scored by hitting specific marked areas of the dartboard.

The modern dartboard is divided into 20 numbered sections with nominal point values ranging from 1 to 20. Two small circles are located at the center of the dartboard; they are collectively known as the bullseye. The inner red circle of the bullseye is commonly referred to as “double-bull” (DB) and is worth 50 points. The outer green circle is typically referred to simply as “bull” (B) and is worth 25 points. The “double ring” is the thin red/green outer ring and scores double the points value of that section. The “treble ring” is the thin red green inner ring and scores triple the points value of that section. Typically, three darts are thrown per turn, so the maximum attainable score for a single turn is 180, by scoring three triple-20s (T20).

In non-professional settings, it is typically the responsibility of the player to manually keep their own score and doing so is cognitively demanding. In the most widely played game format, the player must inspect the dartboard, compute the sum of the individual dart scores, and subtract this amount from their previous total. As trivial as this may seem, manual scorekeeping in darts slows down the pace of the gale and makes it less enjoyable.

Heretofore, several automated dartboard scoring systems have been proposed to improve the playability of darts. Electronic dartboards manufactured with numerous small holes have been used together with plastic-tipped darts to enable automatic scoring. However, this variation of the game known as soft-tip darts lacks the authenticity and feel of traditional steel-tip darts played on a bristle dartboard. As a result, the game of steel-tip darts remains more widely adopted, especially in competitive and professional settings. To provide a r cans for automatic scoring in steel-tip darts, several stereo or multi-camera systems have been proposed. Examples of such systems are disclosed in U.S. Pat. No. 10,317,177B2, US20110031696A1, U.S. Pat. Nos. 10,443,987B2, and 10,126,102B2. These systems require at least two cameras, which are positioned adjacent or near the dartboard, and capture digital images of the dartboard from different perspectives or points of view. The digital images are sent to an auxiliary computing device, where they are processed using various image processing algorithms to estimate the positions of the darts present on the dartboard, and in turn, the dart scores. Such systems score a dart by reconstructing a three-dimensional model of the dart and dartboard using digital images from at least two different perspectives (stereo vision) and a computer vision technique known as triangulation. To perform triangulation, it is necessary to know the parameters of the 3D-to-2d projection function for each camera involved. These parameters include the intrinsic and extrinsic camera parameters, which are obtained through manual camera calibration. Often, greater than two cameras are required to handle cases of visual interference, here in one camera view the position of a dart is occluded by other darts on the dartboard.

While multi-camera automatic dart scoring systems are sufficiently accurate and provide reliable dart score predictions, they possess several drawbacks. First, they are prohibitively expensive because they require customized hardware. Retail systems may cost upwards of ten times the cost of a conventional bristle dartboard, which could deter casual or recreational dart players. Second, these systems may only function with a specific dartboard for which they were designed or may require special lighting arrangements and manual system calibration to function properly. Existing dartboard owners may not want to purchase a new dartboard or expensive cameras and lighting if they wish to take advantage of automatic dart scoring. Similarly, commercial establishments may be reluctant to purchase automatic; dartboard scoring systems that cannot be retrofitted to their existing dartboards. Finally, the cameras and light sources positioned near the dartboard are intrusive; they may be a visual distraction to some players, and they may also be subject to damage caused by inaccurate darts thrown by beginners.

As a result, a system and method for automatically scoring a dartboard that is inexpensive, unintrusive, and may be used with existing dartboard setups is highly desirable.

### SUMMARY

The present disclosure relates to a system and method for automatically scoring a dart game utilizing an inexpensive, single digital image capture device such as a camera, requiring only a single perspective or point of view.

In an aspect, the present system and method is configured to automatically score a dartboard that makes use of a computing device with only a single digital image capture device such as a camera, providing a single perspective or point of view.

In an aspect, there is provided a computer-implemented method for automatically scoring a dartboard, comprising: utilizing a digital image capture device having a sensor for capturing a digital image of a dartboard from a single perspective; utilizing a processor, acquiring in the digital image a plurality of dartboard calibration points in an image plane; utilizing the processor, computing a transformation matrix that transforms any point in an image plane to a corresponding point in a dartboard plane; utilizing the processor, detecting a dart landing position in the image plane, and transforming the dart landing position in the image plane to a dart landing position in the dartboard plane; computing a score of the detected dart based on the dart landing position in the dartboard plane; and displaying the score on a display.

In an embodiment, the computer-implemented method further comprises acquiring calibration points in the image plane comprises acquiring at least four calibration points.

In another embodiment, the computer-implemented method further comprises utilizing a trained neural network to detect the dart landing position in the image plane, and correlating the orientation of the dart relative to the dart landing position.

In another embodiment, the computer-implemented method further comprises extrapolating a dart landing position based on the orientation of the dart if the actual dart landing position is occluded by another previously landed dart.

In another embodiment, the computer-implemented method further comprises displaying the score as an annotated score overlaid onto the digital image and the landing position of the dart.

In another embodiment, the computer-implemented method further comprises displaying the score as an annotated score overlaid onto the digital image and the landing position of the dart, and if the dart landing position is occluded by another previously landed dart, then identifying the score as an extrapolation.

In another embodiment, the computer-implemented method further comprises configuring a computing device as a game controller to control the flow of a dart game.

In another embodiment, the computing device is a mobile phone device having an integrated camera, and the method is executable on the processor and memory of the mobile phone device to automatically score a dart game.

In another embodiment, the computer-implemented method further comprises utilizing two mobile phone devices located in remote locations to automatically score dart games played remotely, utilizing a dartboard and darts in each remote location.

In another embodiment, the computer-implemented method further comprises displaying a score for a remotely located player by displaying a digital image of the remotely located dartboard with an annotated score.

In this respect, before explaining at least one embodiment of the invention in detail, it is to be understood that the invention is not limited in its application to the details of construction and to the arrangements of the components set forth in the following description or the examples provided therein or illustrated in the drawings. Therefore, it will be appreciated that a number of variants and modifications can be made without departing from the teachings of the disclosure as a whole. Therefore, the present apparatus, system, and method is capable of other embodiments and of being practiced and carried out in various ways. Also, it is to be understood that the phraseology and terminology employed herein are for the purpose of description and should not be regarded as limiting.

### BRIEF DESCRIPTION OF THE DRAWINGS

FIG. 1 shows a perspective view of the dartboard and a computing device with connected camera positioned in one arrangement to capture an image of the dartboard.

FIG. 2 shows a front and rear view of the computing device including a front-facing display and rear-facing camera.

FIG. 3 is a flow diagram illustrating how a transformation matrix is computed.

FIG. 4 shows the use of a transformation matrix to transform points in the image plane to corresponding points in the dartboard plane.

FIG. 5 is a flow diagram illustrating actions that may be taken by a game controller during game play.

FIGS. 6A-6J show illustrative digital images captured by the game controller camera in the flow diagram of FIG. 5, with each image being overlayed by the dart score.

FIG. 7 shows a schematic diagram illustrating an example of a remote dart game mode in which players in two or more remote locations can play darts with each other utilizing the present system and method.

FIG. 8 is a schematic block diagram of the illustrative computing device of FIG. 2, which may provide an operating environment for various embodiments of the system and method.

In the drawings, embodiments are illustrated by way of example. It is to be expressly understood that the description and drawings are only for the purpose of illustration and as an aid to understanding and are not intended as describing the accurate performance and behavior of embodiments and a definition of the limits of the invention.

### DETAILED DESCRIPTION

As noted above, the present disclosure relates to a system and method for automatically scoring a dart game utilizing an inexpensive, single camera setup requiring only a single perspective or point of view.

In an aspect, the present system and method is configured to automatically score a dartboard that makes use of a computing device with only a single camera providing a single perspective or point of view.

In an aspect, the present system and method is configured to automatically score a dartboard that makes use of a computing device with only a single camera providing a single perspective or point of view.

In an aspect, there is provided a computer-implemented method. for automatically scoring a dartboard, comprising: utilizing a camera having a sensor for capturing a digital image of a dartboard from a single perspective; utilizing a processor, acquiring in the digital image a plurality of dartboard calibration points in an image plane; utilizing the processor, computing a transformation matrix that transforms any point in an image plane to a corresponding point in a dartboard plane; utilizing the processor, detecting a dart landing position in the image plane, and transforming the dart landing position in the image plane to a dart landing position in the dartboard plane; computing a score of the detected dart based on the dart landing position in the dartboard plane; and displaying the score on a display.

In an embodiment, the computer-implemented method further comprises acquiring calibration points in the image plane comprises acquiring at least four calibration points.

In another embodiment, the computer-implemented method further comprises utilizing a trained neural network to detect the dart landing position in the image plane, and correlating the orientation of the dart relative to the dart landing position.

In another embodiment, the computer-implemented method further comprises extrapolating a dart landing position based on the orientation of the dart if the actual dart landing position is occluded by another previously landed dart.

In another embodiment, the computer-implemented method further comprises displaying the score as an annotated score overlaid onto the digital image and the landing position of the dart.

In another embodiment, the computer-implemented method further comprises displaying the score as an annotated score overlaid onto the digital image and the landing position of the dart, and if the dart landing position is occluded by another previously landed dart, then identifying the score as an extrapolation.

In another embodiment, the computer-implemented method further comprises configuring a computing device as a game controller to control the flow of a dart game.

In another embodiment, the computing device is a mobile phone device having an integrated camera, and method is executable on the processor and memory of the mobile phone device to automatically score a dart game.

In another embodiment, the computer-implemented method further comprises utilizing two mobile phone devices located in remote locations to automatically score dart games played remotely, utilizing a dartboard and darts in each remote location.

In another embodiment, the computer-implemented method further comprises displaying a score for a remotely located player by displaying a digital image of the remotely located dartboard with an annotated score.

In another embodiment, the computing device may be positioned in any location in which its camera has an unobstructed view of the target surface of the dartboard. The computing device acquires digital images of the dartboard and, with its processing units, performs various image processing tasks to compute, in the two-dimensional image coordinates, the locations of at least four dartboard calibration points and the landing positions of any darts that may be present in the dartboard image.

In another embodiment, the dartboard calibration points are not, represented by physical objects but may correspond to any virtual location on the dartboard that can be concisely defined with respect to the dartboard structure (e.g., the center of the dartboard).

In another embodiment, using the detected calibration points, a homography matrix is computed that can transform any point in the image plane to a corresponding point in the dartboard plane.

In another embodiment, mathematical model of the scoring are constructed based on the positions of the transformed calibration points.

In another embodiment, the score of each dart is their classified based on its position on the dartboard.

In another embodiment, the computing device may also be programmed as a game controller to control the flow of the game. The user may interact with the game controller through a user interface located on a display connected to the computing device, which may also act as a scoreboard during game play.

In another embodiment, the user may select from a variety of game modes and specify the number of players.

In another embodiment, the game controller is configured to confirm that the camera has a unobstructed view of the dartboard by searching for and identifying at least four reference image points, and may proceed to direct various aspects of the game including but not limited to scorekeeping, order of play, and the determination of the winner.

In another embodiment, the game controller may also keep a record of player statistics including but not limited to dart throw histories and match outcomes, either locally or on a remote server.

In another embodiment, the game controller may connect wirelessly via the internet to another computing device containing a game controller of the same, and the two controllers may communicate to conduct a virtual match or tournament played remotely using a plurality of dartboards in various remote geographical locations.

In another embodiment, the game controller is configured to display an image the dartboard in a remote geographical location, and in addition overlay on the image with a score. In the event of an occluded landing point where the accuracy of the score is less than 100%, optionally, the game controller may be configured to identify the questionable score for further verification, for example by having the remote player move the game controller off of a camera stand and closer to the dartboard to verify the score from another angle.

The approach described in the present specification is motivated by the idea that reconstructing a three-dimensional model of the dart and dartboard using stereo vision is not a prerequisite for automatic dart scoring.

As will be described in further detail below, in a minimal configuration, the score of a dart can be computed if the position where the dart intercepts the two-dimensional plane representing the dartboard playing surface is known in relation to a set of points in the same plane that defines the scoring area.

In any captured image of a dartboard, the plane representing the dartboard playing surface and the image plane are related through a transformation matrix known as a homography. The homography matrix can be computed using at least four reference image points, and thus the problem can be solved using monocular vision (i.e., using a single image captured by a single camera) if the points of interest can be estimated precisely in the image space.

The problem of localizing points of interest in digital images relates to the scientific study of object and keypoint detection, which are highly researched areas within computer vision, a field of artificial intelligence. Early approaches to object and keypoint detection used hand-designed feature descriptors (e.g., histograms of oriented gradients, scale-invariant feature transforms, etc.) to extract local features for detection purposes. These hand-designed feature descriptors demanded careful designs that were sensitive to different object and keypoint types yet resistant to variations in appearance (e.g., lighting, viewing angle, color, object shape, etc.).

More recently, advances in computer hardware and software have led to the development of data-driven approaches based on deep learning and neural networks. Data-driven deep learning-based approaches automatically learn image features that are more tolerant to appearance variations and therefore provide enhanced accuracy compared to classical image processing techniques. Moreover, deep learning-based approaches are better equipped to handle occlusion, variations in view-point, and illumination changes by including examples of such cases in the training data.

As detailed further below, deep learning and neural networks are exploited to precisely locate points of interest in digital images for the purpose of automatic dart scoring. Advantageously, the trained neural network or AI infers the positions of dartboard calibration points and dart landing positions even when they are not directly visible in the image (e.g., due to self-occlusion or occlusion from other darts), thereby enabling reliable automatic dart scoring using a single-camera system. A detailed technical description of the preferred embodiment of the present invention, including a method for automatically scoring a dartboard using a single image taken from any camera angle, is provided with reference to the attached illustrations and diagrams.

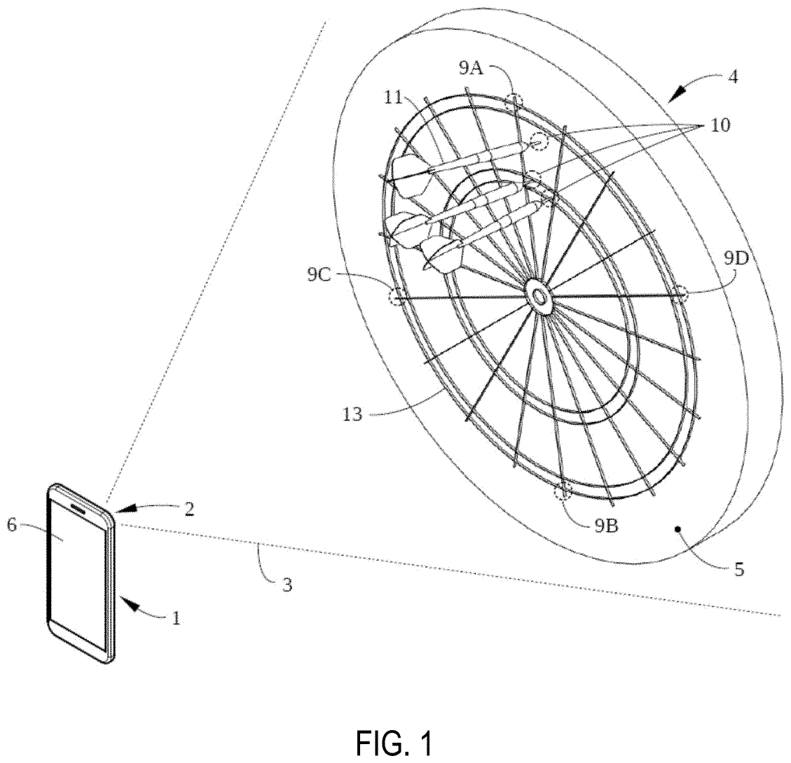

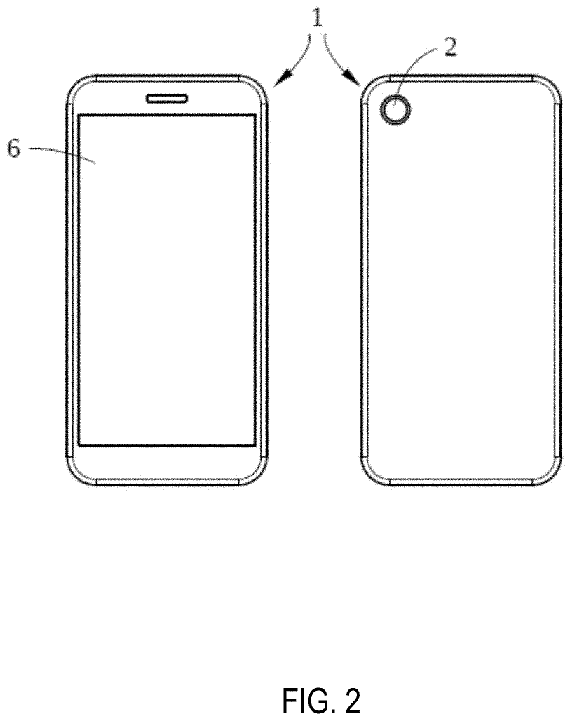

Beginning with FIG. 1, a mobile computing device with front-facing display 6 and rear-facing camera 2 (shown in FIG. 2), henceforth referred to as the “computing device,” is positioned in one arrangement such that the field of view 3 of the rear-facing camera 2 encompasses a conventional bristle dartboard 4, or more specifically, the playing surface 5 of said dartboard 4. In another embodiment, the device 1 may be any portable computing device that is connected, either physically or wirelessly, to a display screen and at least one camera, examples of which include a smartphone or tablet. The camera 2 may be positioned in any location and in any orientation in which the field of view 3 is such that a captured image 7 contains a substantially complete depiction of the dartboard target surface 5. In the preferred embodiment, the data captured by the camera 2 represents an RGB image 7. In another embodiment, the camera 2 may represent any sensor device that acquires image data of any modality (e.g., grayscale images, depth images, lidar images, radar images, etc.).

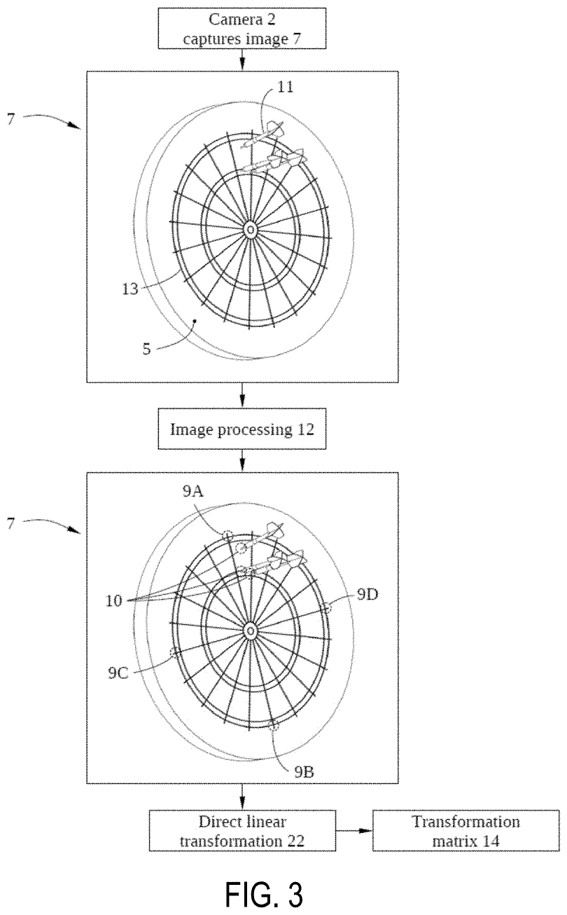

In reference to FIG. 3, the computing device 1 uses a camera 2 to capture an RGB image 7 of the target surface 5. The computing device 1 then uses its processing units, which may be embodied as digital signal processors or the like, to perform various image processing tasks 12 that localize, in the image coordinates, a set of at least four unique calibration points 9A, 9B, 9C, 9D, and a set of points 10 corresponding to the landing positions of any dart 11 that may be present in the image. In FIGS. 1, 3, and 4, the precise locations of the referenced points are represented by the centers of the dashed circles. A calibration point may correspond to any virtual location that can be defined concisely in relation to configuration of the dartboard playing surface 5.

The set of points 9 and 10 produced by the image processing tasks 12 are collectively referred to as “image keypoints” or simply “keypoints.” While the problem of detecting image keypoints for the purpose of automatic dart scoring shares similarities with existing keypoint detection tasks in the computer vision literature (e.g., human pose estimation, hand pose estimation, and facial landmark detection, etc.), there are two key differences:
i. the total number of keypoints to be detected is not known a priori, as there may be any number of darts present in a given dartboard image, and
ii. the darts are indistinguishable from one another and thus cannot be assigned to different keypoint classes.

The widely adopted deep learning approach for regressing keypoint locations using spatial fields called “heatmaps” is ill-equipped for this application because when multiple darts appear close together, their heatmap signals overlap, and isolating individual keypoints from overlapping heatmap signals is challenging and error prone.

To address the aforementioned issues surrounding the use of heatmap-based keypoint detection, the image processing tasks 12 in the preferred embodiment adapt a deep learning-based object detector to perform keypoint detection by modeling keypoints as objects. One embodiment utilizes the notion of a keypoint bounding box, a small square box representing a keypoint at its center. The keypoint detector, which may be embodied as a convolutional neural network or the like, is trained in the same manner as an object detector, using a loss function based on the intersection over union computed using the predicted and target keypoint bounding boxes. During inference, the predicted keypoints exist at the centers of the predicted keypoint bounding boxes. Notably, the keypoint detection method encompassed in the present invention may be used in any application that requires detecting an unknown number of keypoints in an image, where there may be multiple instances of the same keypoint class.

In an embodiment, the image processing tasks 12 may be embodied as a deep convolutional neural network [symbol] (⋅) running on the computing device 1, which takes as input the RGB image I∈ [symbol] ^{h×w×3} 7, where h and w are the height and width of the input image, respectively. The neural network outputs a set of keypoint bounding boxes representing at least 4 dartboard calibration points \hat{P}_{c}={(\hat{χ}ᵢ, [symbol] ᵢ)}ᵢ₌₁⁴ 9 and D dart landing positions \hat{P}_{d}={(\hat{χ}ⱼ, [symbol] ⱼ)}ⱼ₌₁^{D} 10 in the image coordinates, i.e., {(\hat{χ}, [symbol] )∈ [symbol] ²: 0<\hat{χ}<w, 0< [symbol] <h}:

[symbol]

(I)=(\hat{P}_{c},\hat{P}_{d}).

The calibration points 9A, 9B, 9C, 9D represent the arrangement of calibration points in the preferred embodiment. They are located on the outer edge of the double ring 13, and coincide with the intersections of the dartboard scoring sections numbered 5 and 20, 13 and 6, 17 and 3, and 8 and 11, respectively, on a conventional dartboard.

In another embodiment, there may be more than four calibration points, and the calibration points may be in different locations. Using the correspondence between the computed set of calibration points \hat{P}_{c} and their known locations on the dartboard playing surface 5, the homography transformation matrix Ĥ 14, which is a 3×3 invertible matrix that transforms any point in the image plane to a corresponding point in the dartboard plane, has a closed-form solution and is computed via a direct linear transformation algorithm 22. To obtain the corresponding points \hat{P}′_{c} 16 and \hat{P}′_{d} 17 in the dartboard plane, the transformation is performed as follows:

$$[ \begin{matrix}{\hat{x}}^{′} \cdot λ \\ {\hat{y}}^{′} \cdot λ \\ λ\end{matrix} ] = \hat{H} [ \begin{matrix}\hat{x} \\ \hat{y} \\ 1\end{matrix} ]$$

where χ′ and [symbol] are the predicted coordinates of a point in the dartboard plane.

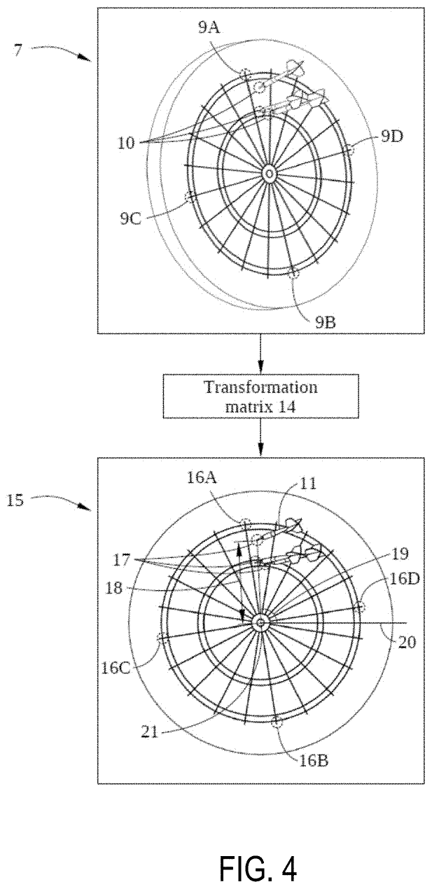

As shown in FIG. 4, the homography transformation matrix 14 may be used to transform the calibration points 9A, 9B, 9C, 9D and the dart landing positions 10 into the plane of the dartboard. playing surface 5. The transformed calibration points 16A, 16B, 16C, 16D and the transformed dart landing positions 17 are overlaid on the transformed RGB image 15. Using the known radii of the circles included in a standard dartboard scoring area, the score of any dart may be classified based on the position of its transformed landing position 17 relative to the center of the dartboard 21, which is computed as the geometric mean of the transformed calibration points 16A, 16B, 16C, 16D. More specifically, the dart score classification is performed based on the distance 18 between the transformed landing position 17 and the center of the dartboard 21, and the angle 19 from any reference direction 20. The total score of the dartboard obtained by computing the sum of the individual dart scores. The represented mapping of dartboard image keypoints to dart scores is referred to as the scoring function ϕ(⋅):

Ŝ=ϕ(\hat{P}_{c},\hat{P}_{d}).

To improve the accuracy of the dart score predictions, the preferred embodiment uses several data augmentation strategies during the training of [symbol] . Some of the disclosed strategies change the positions of the darts while keeping the calibration points fixed, so as to not confuse the neural network regarding the relative positioning of the calibration points, while others change the positions of the calibration points and the dart locations collectively. Each of the disclosed augmentation strategies are described below. For dartboard flipping and dartboard rotation, the augmentation is performed on the transformed RGB image I′ 15, the ground-truth transformed calibration points P_{c}′, and the ground-truth transformed dart landing positions P_{d}′ before transforming back to the original perspective using the inverse homography transformation matrix H⁻¹.
Dartboard Flipping: I′ and P_{d}′ are randomly flipped horizontally and/or vertically while P_{c}′ remains fixed.
Dartboard Rotation: I′ and P_{d}′ are randomly rotated in the image plane in the range [−180°, 180] using a step size of 18° or 36° while P_{c}′ remains fixed. A step size of 18° keeps the dartboard sections aligned, where either a white or black section may appear at the top. A step size of 36° ensures only black sections appear at the top.
Small Rotations: To account for dartboards that are not perfectly vertically aligned, small random rotations in the range [−2°, 2°] are applied to I, P_{c}, and P_{d}.
Perspective Warping: To help generalize to various camera angles, random warping of the image perspective is applied. To implement perspective warping in a principled manner, H⁻¹ is randomly perturbed before I′, P_{c}′, and P_{d}′ are transformed back to the original perspective. A hyperparameter ρ is used to vary the amount of perspective warping. Specifically, the non-diagonal elements of H⁻¹ are randomly scaled by factors sampled from a uniform distribution in the range [0, ρ]. To illustrate the effect of the perspective warping augmentation, it is helpful to consider a scenario when the non-diagonal elements of are scaled equally by a constant s_{ρ}. When s_{ρ}=0, H⁻¹ is approximately equal to the identity matrix and the image remains in a face-on perspective, i.e showing a perfectly circular dartboard. When s_{ρ}=1, H⁻¹ is unchanged and the image is transformed back to its original perspective. For 0<s_{ρ}<1, the warped perspective is an interpolation between the face-on and original perspective. When s_{ρ}>1, the warped perspective is an extrapolation of the original perspective. During the training of [symbol] , the non-diagonal elements of H⁻¹ are scaled separately and randomly to increase variability and improve generalization.

To demonstrate the efficacy of the present system and method, a total of 16,050 dartboard images containing 32,027 darts were manually collected and annotated. These digital images originated from two different dartboard setups, and thus were separated into two datasets D1 and D2. The primary dataset D1 included 15,000 digital images collected using a smartphone camera positioned to capture a face-on view of the dartboard, The second dataset D2 contained the remaining 1050 digital images, which were taken from various camera angles using a digital single-lens reflex camera mounted on a tripod. Several windows were in the vicinity of the dartboards, and images were collected during the day and at night, which provided a variety of natural and artificial lighting conditions. In some lighting conditions, the darts cast shadows on the dartboard. Several edge cases were encountered during the data collection. For example, flights would occasionally dislodge upon striking the dartboard and fall to the ground. In rare cases, the tip of a thrown dart would penetrate the stem of a previously thrown dart and reside there, never reaching the dartboard. In four data collection sessions amounting to 1,200 digital images, the score of each dart was also recorded. This information was used to assess the accuracy of the data annotation process.

All digital images were annotated by a single person using a custom--made annotation tool. Up to seven keypoints (χ, [symbol] ) were labeled in each image, including four dartboard calibration points P_{c}, and up to three dart landing positions P_{d}. In face-on views of the dartboard, the exact position of a dart was often not visible due to self-occlusion, as the dart barrel and flight tended to obstruct the view of the dart tip. Occasionally, there was occlusion from other darts as well. In such cases, the dart landing position was inferred at the discretion of the annotator. To assess the accuracy of the labeling process, the scores of the labeled darts were computed using the scoring function ϕ(P_{c}, P_{d}) and were compared against the actual scores of the 1,200 darts that were recorded during the data collection. The labeled and actual scores matched for 97.6% of the darts.

An accuracy metric called Percent Correct Score (PCS) was introduced to evaluate the accuracy of the proposed system. It represents the percentage of dartboard image samples whose predicted total score ΣŜ matches the labeled total score ΣS. PCS is easy to interpret and considers false positives and false negatives via evaluation of the total score of the dartboard, as opposed to the individual dart scores. Over a dataset with N images, the PCS is computed as follows:

$$P C S = \frac{100}{N} {\sum }_{i = 1}^{N} δ ( ( \sum {\hat{S}}_{i} - \sum {S}_{i} ) = 0 ) \% .$$

On held out test sets of D1 and D2 containing 2,000 and 150 images, respectively, an embodiment of the disclosed invention achieved a PCS of 94.7% and 84.0%, respectively. The most common failure mode was missed dart detections due to occlusion from other darts. In actual deployment, some of these errors could be accounted for as they would be detectable when a previous dart prediction with high confidence suddenly disappears. The second most common error occurred when darts were on the edge of a section and were incorrectly scored. In rare cases, the ground-truth labels were incorrect, darts were not detected due to unusual dart orientations, or calibration points were missed due to dart occlusion. In another embodiment, the neural network could be trained to detect redundant calibration points or with more training images to improve the accuracy of the system.

It will be appreciated that the particular training example as described above using a limited data set is provided by way of example, and not by way of limitation. Thus, it would be possible to use a very large dataset of digital images of dartboards and darts to iteratively train the neural network to a high degree of accuracy, and after calibrating the present system and method accordingly, a PCS approaching 99.0% or higher may be achieved. This is comparable to more expensive, dedicated multi-camera dart systems which may achieve accuracy of over 99.0%, and approaching but not reaching 100% accuracy.

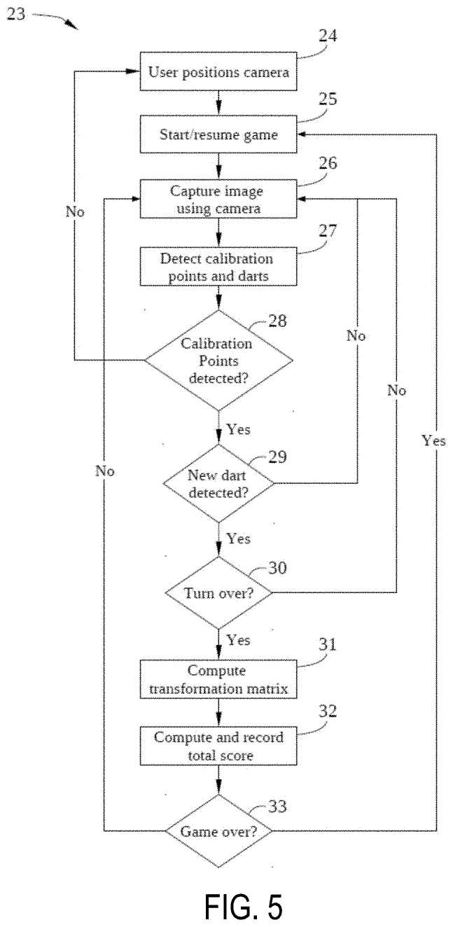

Now referring to FIG. 5, shown is a flow diagram 23 in accordance with an embodiment, which may be used in conjunction with a game controller programmed on the computing device 1 to automatically score a game of darts and control the flow of a game play.

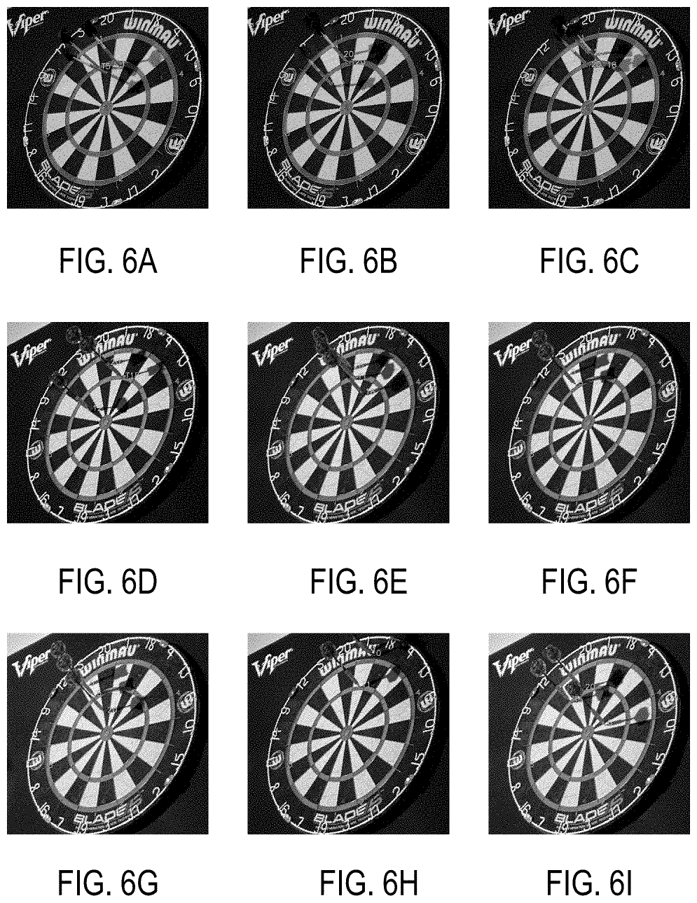

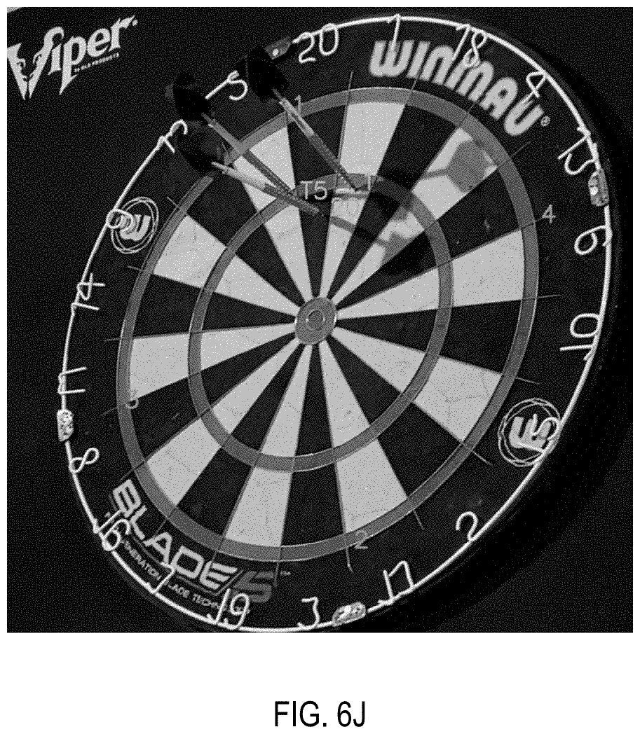

In an embodiment, the user begins at 24 by positioning the computing device 1 such that its camera 2 is directed towards the dartboard 4. The user may interact with the game controller at 25 via a display 6 and specify the desired game mode, the number of players, and choose whether to start a new game or resume a game in progress. Once the game has been started or resumed, the game controller proceeds to 26 and captures an RGB image 7 of the dartboard 4 using the camera 2. Illustrative examples of a series of photo images captured by the game controller are shown by way of example in FIGS. 6A-6I.

At 27, the controller uses the image processing tasks 12 to detect the calibration points 9A, 9B, 9C, 91) and any dart landing positions 10 in the RGB image 7. If no calibration points are detected at 28, the game controller returns to 24 and instructs the user to reposition the camera 2 such that it has a clear and unobstructed view of the dartboard 4.

If at least four calibration points are detected at 28, the game controller checks at 29 whether any new dart landing positions were detected by comparing the dart landing positions from the current image to those from the previous image. If no new dart landing positions were detected, the controller returns to 26 and captures a new image. If at 29 a new dart is detected, the controller checks at 30 whether the turn of the current player has ended. In one embodiment, the end of a turn may be signaled by a simple criterion, such as whether three darts have been detected. The player may also manually interact with the game controller to signal the end of the turn. If the turn has ended, the controller computes the transformation matrix 14 and the individual scores of each dart at 31. The position and score of each dart may be recorded for statistical purposes. At 32, the total score for the turn is recorded and some game-related information may be displayed to the user. At 33, the controller checks whether the game has ended. If the game has not ended, it returns to 26 to begin the turn of the next player. If the game has ended, it returns to 24, where the user may choose to start a new game.

In an embodiment, as shown in FIG. 6J, an enlargement of the image captured by the game controller at FIG. 6A is shown, wherein each photo image of the dart shows the landing location of each dart, and the corresponding score as calculated by the game controller. In this illustrative example, the location and score of a new dart that has landed is indicated by text shown in a bright offset color, such that the landing spot and score are viewable by each player in each remote location.

In another embodiment, rather than a series of digital images, the camera may be configured to capture and stream video of a dart game in real time, and the game controller may be configured to detect whenever a dart has landed in order to create a digital image to be processed by the game controller.

While the neural network as described above may be trained to extrapolate from the relative positions of the darts and calculate a score even when a dart landing location is partially or fully occluded by another dart, in this event, if the confidence level for a score calculated by the neural network is less than 100%, the score for that dart may be indicated in a different color, such that a player a remote location may challenge the score if desired. In this event, the score may be verified in a number of ways, by having a remote player confirm the score, with verification if required by moving a camera into an unobstructed view without touching the darts to show a remotely located player that the score is verified. If in the unlikely event that an error has been made by the game controller, the game controller may be configured to allow the players to manually override the score made in error.

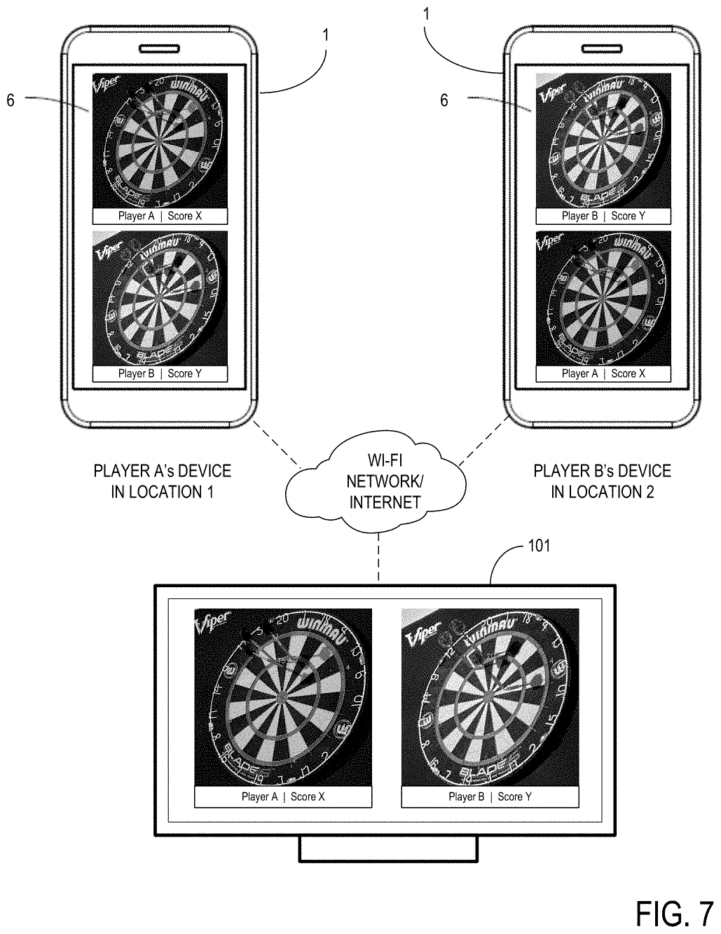

FIG. 7 shows a schematic diagram illustrating an example of a remote dart game mode in which players in two or more remote locations can play darts with each other utilizing the present system and method. In this illustrative example, Player A is located in Location 1, and Player B is located in Location 2. Each player sets up their computing device and digital image capture device, in this case a mobile phone or smart phone with a built-in camera, to provide a clear view of a dartboard set up at their respective location. The smart phones can be set up using telescoping stands with gooseneck or ball head mounts in known manner. Once set up, each smart phone device acts as a game controller to verify that at least four calibration points appear in the image, and that automatic scoring of the dart game can occur.

In an embodiment, the respective smart phones of Player A and Player B can be operatively connected over a network, such as one or more Wi-Fi networks, and possibly connected over the Internet, such that the two players can be located anywhere around the world. Their respective phones may be configured to display an image of their own dartboard, as well as the dartboard of the remotely located player. The present system and method tracks the respective scores of Player A and Player B, and displays the score of each player as the game progresses.

In another embodiment, one or both smart phone devices may be operatively connected to a separate display, such as a smart TV 101 wirelessly connected to a Wi-Fi network at Location 1 or Location 2 to be viewed respectively by Player A and Player B, and any audiences in those locations. Alternatively, the smart TV 101 may also be set up in a separate Location 3, in order to be viewed by audience members in a different location from both Player A and Player B.

It will be appreciated that this is just an illustrative example of two players playing remotely, but various other configurations are possible such that more than two players in more than two locations could be operatively connected through their respective devices, in order to allow a round-robin tournament, or other tournament formats such as single elimination or double elimination, etc.

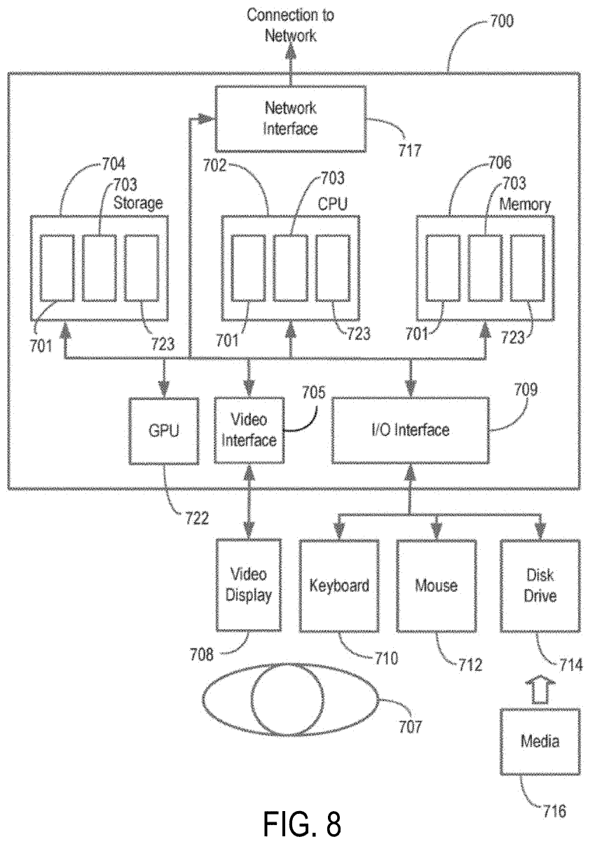

Now referring to FIG. 8 shown is a schematic block diagram of a generic computing device that may provide a suitable operating environment for one or more embodiments of the system and method as described above. A suitably configured computer device, and associated communications networks, devices, software and firmware may provide a platform for enabling one or more embodiments as described above. By way of example, FIG. 8 shows a generic computer device 700 that may include a central processing unit (“CPU”) 702 connected to a storage unit 704 and to a random access memory 706. The CPU 702 may process an operating system 701, application program 703, and data 723. The operating system 701, application program 703, and data 723 may be stored in storage unit 704 and loaded into memory 706, as may be required. Computer device 700 may further include a graphics processing unit (GPU) 722 which is operatively connected to CPU 702 and to memory 706 to offload intensive image processing calculations from CPU 702 and run these calculations parallel with CPU 702. An operator 710 may interact with the computer device 700 using a video display 708 connected by a video interface 705, and various input/output devices such as a keyboard 710, pointer 712, and storage 714 connected by an I/O interface 709. In known manner, the pointer 712 may be configured to control movement of a cursor or pointer icon in the video display 708, and to operate various graphical user interface (GUI) controls appearing in the video display 708. The computer device 700 may form part of a network via a network interface 711, allowing the computer device 700 to communicate with other suitably configured data processing systems or circuits. A non-transitory medium 716 may be used to store executable code embodying one or more embodiments of the present method on the generic computing device 700.

While mobile phone or smart phone devices have been used as an example of a computing device which may be used to implement various embodiments of the present system and method, it will be appreciated that various modifications may be made, such as having a separate digital image capture device, such as a Web-cam, which is wirelessly connected to the computing device. The computing device may also be a tablet, a laptop computer, a desktop computer, or even a purpose built device which may implement various features of the present system and method in firmware or application specific hardware. However, the development costs of such purpose-built systems and hardware may significantly increase the costs of implementation.

Thus, in an aspect, there is provided a computer-implemented method for automatically scoring a dartboard, comprising: utilizing a digital image capture device having a sensor for capturing a digital image of a dartboard from a single perspective; utilizing a processor, acquiring in the digital image a plurality of dartboard calibration points in an image plane; utilizing the processor, computing a transformation matrix that transforms any point in an image plane to a corresponding point in a dartboard plane; utilizing the processor, detecting a dart landing position in the image plane, and transforming the dart landing position in the image plane to a dart landing position in the dartboard plane; computing a score of the detected dart based on the dart landing position in the dartboard plane; and displaying the score on a display.

In an embodiment, acquiring calibration points in the image plane comprises acquiring at least four calibration points.

In another embodiment, the method further comprises utilizing a trained neural network to detect the dart landing position in the image plane, and correlating the orientation of the dart relative to the dart landing position.

In another embodiment, the method further comprises extrapolating a dart landing position based on the orientation of the dart if the actual dart landing position is occluded by another previously landed dart.

In another embodiment, the method further comprises displaying the score as an annotated score overlaid onto the digital image and the landing position of the dart.

In another embodiment, the method further comprises displaying the score as an annotated score overlaid onto the digital image and the landing position of the dart, and if the dart landing position is occluded by another previously landed dart, then identifying score as an extrapolation.

In another embodiment, the method further comprises configuring a computing device as a game controller to control the flow of a dart game.

In another embodiment, the computing device is a mobile phone device having an integrated camera as the digital image capture device, and the method is executable on the processor and memory of the mobile phone device to automatically score a dart game.

In another embodiment, the method further comprises utilizing two or more mobile phone devices located in remote locations to automatically score dart games played remotely, utilizing a dartboard and darts in each remote location.

In another embodiment, the method further comprises displaying a score for a remotely located player by displaying a digital image of the remotely located dartboard with an annotated score.

In another aspect, there is provided a computer-implemented system for automatically scoring a dartboard, comprising: a digital image capture device having a sensor for capturing a digital image of a dartboard from a single perspective; at least one computing device with a processor, memory, and storage, the at least one computing device adapted to: acquire in the digital image a plurality of dartboard calibration points in an image plane; compute a transformation matrix that transforms any point in an image plane to a corresponding point in a dartboard plane; detect a dart landing position in the image plane, and transforming the dart landing position in the image plane to a dart landing position in the dartboard plane; compute a score of the detected dart based on the dart landing position in the dartboard plane; and display the score on a display.

In an embodiment, acquiring calibration points in the image plane comprises acquiring at least four calibration points.

In another embodiment, the system is further configured to utilize a trained neural network to detect the dart landing position in the image plane, and correlating the orientation of the dart relative to the dart landing position.

In another embodiment, the system is further configured to extrapolate a dart landing position based on the orientation of the dart if the actual dart landing position is occluded by another previously landed dart.

In another embodiment, the system is further configured to display the score as an annotated score overlaid onto the digital image and the landing position of the dart.

In another embodiment, the system is further configured to display the score as an annotated score overlaid onto the digital image and the landing position of the dart, and if the dart landing position is occluded by another previously landed dart, then identifying the score as an extrapolation.

In another embodiment, the system is configured as a game controller to control the flow of a dart game.

In another embodiment, the computing device is a mobile phone device having an integrated camera as the digital image capture device, and the mobile phone device is configured to automatically score a dart game.

In another embodiment, two or more mobile phone devices located in remote locations are operatively connected over a network to automatically score dart games played remotely, utilizing a dartboard and darts in each remote location.

In another embodiment, the system is further configured to display a score for a remotely located player by displaying a digital image of the remotely located dartboard with an annotated score.

While various illustrative embodiments of the system, method, and apparatus have been described, it will be appreciated that various modifications and amendments may be made without departing from the scope of the invention.

1. A computer-implemented method for automatically scoring a dartboard, comprising:
utilizing a digital image capture device having a sensor for capturing a digital image of a dartboard from a single perspective;
utilizing a processor, acquiring in the digital image a plurality of dartboard calibration points in an image plane;
utilizing the processor, computing a transformation matrix that transforms any point in an image plane to a corresponding point in a dartboard plane;
utilizing the processor, detecting a dart landing position in the image plane, and transforming the dart landing position in the image plane to a dart landing position in the dartboard plane;
computing a score of the detected dart based on the dart landing position in the dartboard. plane; and
displaying the score on a display.

2. The computer-implemented method of claim 1, wherein acquiring calibration points in the image plane comprises acquiring at least four calibration points.

3. The computer-implemented method of claim 1, further comprising utilizing a trained neural network to detect the dart landing position in the image plane, and correlating the orientation of the dart relative to the dart landing position.

4. The computer-implemented method of claim 3, further comprising extrapolating a dart landing position based on the orientation of the dart if the actual dart landing position is occluded by another previously landed dart.

5. The computer-implemented method of claim 3, further comprising displaying the score as an annotated score overlaid onto the digital image and the landing position of the dart.

6. The computer-implemented method of claim 3, further comprising displaying the score as an annotated score overlaid onto the digital image and the landing position of the dart, and if the dart landing position is occluded by another previously landed dart, then identifying the score as an extrapolation.

7. The computer-implemented method of claim 1, further comprising configuring a computing device as a game controller to control the flow of a dart game.

8. The computer-implemented method of claim 7, wherein the computing device is a mobile phone device having an integrated camera as the digital image capture device, and the method is executable on the processor and memory of the mobile phone device to automatically score a dart game.

9. The computer-implemented method of claim 8, further comprising utilizing two or more mobile phone devices located in remote locations to automatically score dart games played remotely, utilizing a dartboard and darts in each remote location.

10. The computer-implemented method of claim 9, further comprising displaying a score for a remotely located player by displaying a digital image of the remotely located dartboard with an annotated score.

11. A computer-implemented system for automatically scoring a dartboard, comprising:
a digital image capture device having a sensor for capturing a digital image of a dartboard from a single perspective;
at least one computing device with a processor, memory, and storage, the at least one computing device adapted to:
acquire in the digital image a plurality of dartboard calibration points in an image plane;
compute a transformation matrix that transforms any point in an image plane to a corresponding point in a dartboard plane;
detect a dart landing position in the image plane, and transforming the dart landing position in the image plane to a dart landing position in the dartboard plane;
compute a score of the detected dart based on the dart landing position in the dartboard plane; and
display the score on a display.

12. The system of claim 11, wherein acquiring calibration points in the image plane comprises acquiring at least four calibration points.

13. The system of claim 11, wherein the system is further configured to utilize a trained neural network to detect the dart landing position in the image plane, and correlating the orientation of the dart relative to the dart landing position.

14. The system of claim 13, wherein the system is further configured to extrapolate a dart landing position based on the orientation of the dart if the actual dart landing position is occluded by another previously landed dart.

15. The system of claim 13, wherein the system is further configured to display the score as an annotated score overlaid onto the digital image and the landing position of the dart.

16. The system of claim 13, wherein the system is further configured to display the score as an annotated score overlaid onto the digital image and the landing position of the dart, and if the dart landing position is occluded by another previously landed dart, then identifying the score as an extrapolation.

17. The system of claim 11, wherein the system is configured as a game controller to control the flow of a dart game.

18. The system of claim 17, wherein the computing device is a mobile phone device having an integrated camera as the digital image capture device, and the mobile phone device is configured to automatically score a dart game.

19. The system of claim 18, wherein two or more mobile phone devices located in remote locations are operatively connected over a network to automatically score dart games played remotely, utilizing a dartboard and darts in each remote location.

20. The system of claim 19, wherein the system is further configured to display a score for a remotely located player by displaying a digital image of the remotely located dartboard with an annotated score.
